(19) United States
(12) Patent Application Publication
(10) Pub. No.: US 2002/0163507 A1
(43) Pub. Date: Nov. 7, 2002

(54) Touch panel display aiding interface

(76) Inventor: Chi-Lei Kao, Taipei (TW)

Correspondence Address: J.C. Patents, Inc., Suite 114, 1340 Reynolds Ave., Irvine, CA, 92614, US

(21) Appl. No.: 09/920,403

(22) Filed: Jul. 31, 2001

(30) Foreign Application Priority Data
May 7, 2001 (TW) 90110811

(51) Int. Cl. G09G 5/00

(52) U.S. Cl. 345/173

(57) ABSTRACT

A touch panel display aiding interface performs the operations of a computer pointing device on a touch panel display screen. The touch panel display aiding interface comprises a pointing object, at least a button object and a rolling-action object shown on the touch panel display screen. When the user by means of a pointing member touches the button object on the touch panel display screen, the aiding interface simulates a mouse pressing. When the user touches the rolling-action, the aiding interface simulates a mouse rolling. When the user touches the button object while moving the pointing member, the pointing object moves along with the pointing member.

This application claims the priority benefit of Taiwan application serial no. 90110811, filed May 7, 2001.

### BACKGROUND OF THE INVENTION

1. Field of the Invention

The invention relates to a touch panel display system. More particularly, the present invention relates to a touch panel display aiding interface.

2. Description of the Related Art

The computer pointing device introduced by Douglas Engelbart in 1968, well known as “the mouse”, has substantially contributed to the expansion and development of computer systems. The computer pointing device invented by Engelbart enables a computer user with the mouse in hand to manipulate an on-screen pointer to select, move, and change items on the screen. Since Engelbart, computer technology has greatly expanded and the mouse increasingly becomes more sophisticated to provide, for example, 3D operations for computer-aided design systems.

Recently, the development of touch sensitive panel screens, also simply called “touch panel” screens, offers an alternative to the traditional mouse by allowing the user to select the items shown on the monitor screen by directly touching the monitor screen. The technology of touch panel screens thus provides the user with a more comfortable use without any pointing devices, which is extensively used in hand-held multimedia devices such as “electronic pocket agenda”, for example.

Although touch panel screen technology may provide a more comfortable use, the absence of mouse devices may disable some convenient operations provided by the traditional mouse. An improved touch panel screen technology thus should be one that incorporates the operations performed by the traditional mouse.

### SUMMARY OF THE INVENTION

An aspect of the present invention is to provide a touch panel display aiding interface that can simulate the operations of a mouse device and thereby provides the user with a more convenient and comfortable use of the touch panel display screen.

To attain at least the foregoing objectives, the present invention provides a touch panel display aiding interface that comprises, according to an embodiment, a pointing object, at least a button object, and at least a rolling-action object. The pointing object, the button object, and the rolling-action object may be represented by various shaped icons on the touch panel display screen. The pointing object may show the location touched by the user represented by (x, y) coordinates on the touch panel display screen. When touched by the user, the button object may simulate, for example, the click of a mouse button. When touched by the user, the rolling-action object may simulate, for example, a mouse rolling. The button object and rolling-action object may move along with the pointing object, and the location of the pointing object, button objects, and rolling-action objects are restricted to be within the limits of the touch panel display screen.

An aiding interface including the above-described elements comprises, according to an embodiment of the present invention, the following operations. When a user touches a first location of the touch panel display screen, the pointing object moves to a location proximate to the touched first location. The button object and the rollingaction object simultaneously move along with the pointing object to a location proximate to the pointing object. When the user touches a second location of the touch panel display screen, the pointing object, the button object and the rolling-action object move to a location proximate to the touched second location. The respective locations of the pointing object, button object, and rolling-action object relative to the location touched on the touch panel display screen are adequately evaluated such that the different objects are not out of the limits of the touch panel display screen. If the user touches the button object, a mouse button click is simulated. If the user touches the rolling-action object, a mouse rolling is simulated. If the user touches, for example by means of his or her finger, the button object while moving his or her finger, the pointing object, the button object, and the rolling-action object move along with the finger. A mouse moving simultaneous to a continuous pressing of a mouse button such as for a conventional “drag” operation hence can be simulated.

By providing the above touch panel display aiding interface, the present invention advantageously can perform the operations performed by a traditional mouse, which provides a more comfortable and convenient use of the touch panel display screen.

To attain at least the foregoing objectives and advantages, a touch panel display interface, according to another embodiment of the present invention, comprises the following elements. The aiding interface comprises a pointing object, at least a button object, and at least a rolling-action object, such as described above. When the user touches a first location of the touch panel display screen, the pointing object preferably does not move toward the touched first location as in the previous embodiment. When the user touches a second location of the touch panel display screen, the pointing object, the button object and the rolling-action object run a distance parallel to a line from the first location to the second location. When the user touches the button object, a mouse button click is simulated. When the user touches the rolling-action object, a mouse rolling is simulated. When the user touches, for example by means of his or her finger, the button object and simultaneously moves his or her finger, the pointing object, the button object, and the rolling-action object move along with the finger.

With the above-described touch panel display aiding interface, the present invention can simulate the 2D or 3D operations of a traditional mouse on a touch panel display screen.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 and FIG. 2 are sketches schematically illustrating a touch panel display aiding interface according to various embodiments and examples of the present invention.

### DESCRIPTION OF THE PREFERRED EMBODIMENTS

The following detailed description of the embodiments and examples of the present invention with reference to the accompanying drawings is only illustrative and not limiting. Wherever possible, like reference numerals refer to like elements in the drawings unless otherwise illustrated.

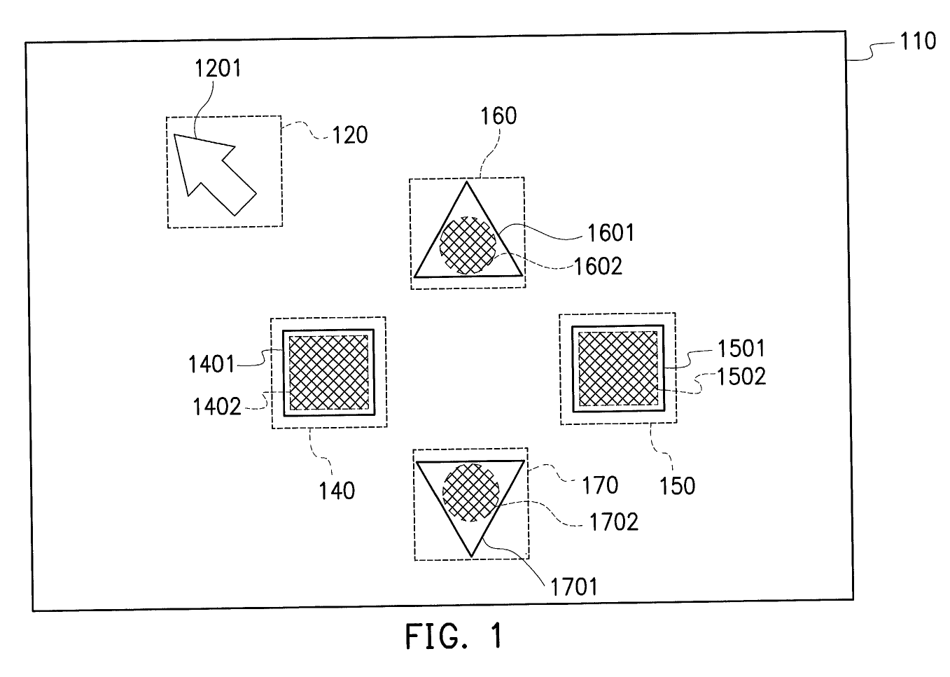

Referring now to FIG. 1, a schematic sketch illustrates a touch panel display aiding interface according to an embodiment of the present invention. The aiding interface is suitable for use with a touch panel display screen 110. The touch panel display aiding interface comprises, for example, a pointing object 120, a left button object 140, a right button object 150, an up-rolling object 160, and a down-rolling object 170. The pointing object 120 includes a pointing icon 1201. The left button object 140 includes a left button icon 1401 and a left button region 1402. The right button object 150 includes a right button icon 1501 and a right button region 1502. The up-rolling object 160 includes an up-rolling icon 1701 and an up-rolling region 1702. The down-rolling object 170 includes a down-rolling icon 1701 and a down-rolling region 1702. The pointing icon 1201 can be, for example, arrow-like shaped, the left button icon 1401 and right button icon 1501 include, for example, a rectangular shape, and the up-rolling icon 1601 and down-rolling icon 1701 a triangular shape. The left and right button regions 1402 and 1502, the up-rolling region 1602 and down-rolling region 1702 respectively indicate the object regions that should be effectively touched to trigger an action of the aiding interface.

The following description illustrates the operation of a touch panel display aiding interface according to an embodiment of the present invention. When a user touches a first location of the touch panel display screen 110, for example a location having coordinates (1,1), the pointing object 120 moves to a location calculated to be proximate to the first location touched, which can be for example the location (0,2). Simultaneously, the left button object 140, the right button object 150, the up-rolling object 160 and the down-rolling object 170 may move along with the pointing object 120 to a location proximate to the pointing object 120.

When the user touches a second location, for example the location (2,2), the pointing object 120, the left button object 140, the right button object 150, the up-rolling object 160, and the down-rolling object 170 move towards the second location touched on the touch panel display screen 110. In the above example, the objects (120, 140, 150, 160, 170) consequently identically run a distance \sqrt{(1²+1²)}=√2, equal to the distance between the first location and second location touched on the touch panel display screen 110, along a direction that increases the abscissas and ordinates. The pointing object 120, for example, thus moves from the location (0,2) to the location (1,3). The locations of the different objects (120, 140, 150, 160, 170) with respect to the touched location may be evaluated such that they appear within the limits of the touch panel display screen 110.

When the user touches the left button region 1402, the touch panel display aiding interface of the invention simulates, for example, the click of a pointing device button such as the click of the mouse left button, for example. When the user touches the right button object 1501, the touch panel display aiding interface of the invention may simulate the click of another pointing device button such as the click of the mouse right button, for example.

When the user touches the up-rolling region 1602, the aiding interface of the invention may simulate a pointing device move in a first direction such as an upward move on the touch panel display screen 110, for example. When the user touches the down-rolling region 1702, the aiding interface of the invention may simulate the pointing device move in a second direction opposite to the first direction such as the downward move on the touch panel display screen 110, for example. The pointing object 120 thus may move upward or downward depending on whether the object 160 or 170 is touched.

When the user, by means of his or her finger for example, simultaneously touches the left button region 1402 and moves his or her finger, the objects (120, 140, 150, 160, 170) together may move along with the finger, for example. Such an operation typically simulates, for example, the “drag” action of the traditional mouse.

The above description illustrates an example of operation of the invention which provides the user with a comfortable and convenient use of the touch panel display screen without any conventional pointing device such as a traditional mouse. Another example of operation of the present invention is described hereafter in accordance with a second embodiment of the present invention.

In the second embodiment, when the user touches a location of the touch panel display screen, the pointing object 120 does not move towards the location touched by the user. Instead, the pointing object 120 preferably move along a direction parallel to a line from the first location to the second location touched by the user. Hence, if the user touches a first location of the touch panel display screen 110, for example the location (1,1), the pointing object 120 does not move to a location proximate to the location (1,1). The pointing object may be, for example, at the location (6,6). Then, if the user touches a second location of the touch panel display screen 110, for example (2,2), the pointing object 120 runs a distance which is, for example, equal to the distance between the first location and second location touched on the touch panel display screen 110. The direction along which the pointing object 120 moves is parallel to the direction from the first location to the second location touched on the touch panel display screen 110. In the example, the pointing object 120 consequently runs a distance ²+1²)=√2 from the location (6,6) along a direction that increases the abscissas and ordinates to the location (7,7). Simultaneously, the left button object 140, right button object 150, uprolling object 160, and down-rolling object 170 may move along with the pointing object 120 to a location proximate to the pointing object 120.

When the user touches the left button region 1402, the touch panel display aiding interface of the invention may simulate, for example, the click of a pointing device button such as the click of the mouse left button, for example. When the user touches the right button object 1501, the touch panel display aiding interface of the invention may simulate the click of another pointing device button such as the click of the mouse right button, for example.

When the user touches the up-rolling region 1602, the aiding interface of the invention may simulate, for example, a pointing device move in a first direction such as the upward move on the touch panel display screen 110. When the user touches the down-rolling region 1702, the aiding interface of the invention may simulate, for example, the pointing device move in a second direction opposite to the first direction such as the downward move on the touch panel display screen 110.

When the user, by means of his or her finger for example, simultaneously touches the left button region 1402 and moves his or her finger, the objects (120, 140, 150, 160, 170) may move along with the finger, for example.

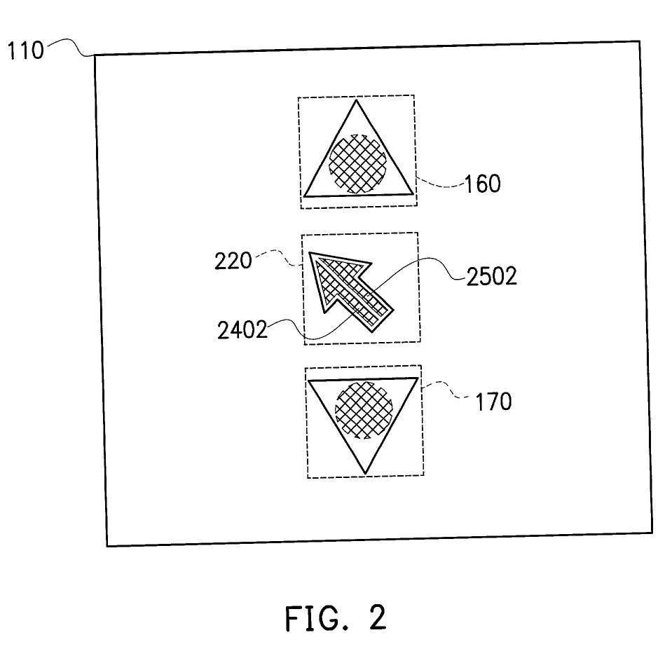

It will be apparent to those skilled in the art that various modifications and variations can be made to the structure and operations of the present invention without departing from the scope of the invention. For example, the pointing object may serve as pointer and further may integrate the functions of one or more button and/or rolling objects, as illustrated in FIG. 2. FIG. 2 illustrates a configuration where the aiding interface may be embodied in a pointing object 220 for example arrow-like shaped. The pointing object 220 may include a first button object region 2402 and a second button object region 2502, for example. One advantage of such a representation is, for example, better ergonomics of the display on the touch panel display screen 110. The first button object region 2402 and second button object region 2502 respectively may operate as, for example, a mouse left and right button when touched by the user. As shown in FIG. 2, the aiding interface may optionally include other objects such as rolling-action objects 160 and 170 of the previous embodiments, for example. The operation of the aiding interface as embodied in FIG. 2 can be similar to the operation described in the previous embodiments.

In conclusion, the present invention provides the user of the touch panel display screen with an aiding interface that advantageously can perform the operations of the traditional computer pointing devices. As a result, the use of touch panel display screen is more comfortable.

What is claimed is:

1. A touch panel display aiding interface suitable for use with a touch panel display screen, wherein an user may touch different locations of the touch panel display screen by means of a pointing member, the aiding interface comprising:
a pointing object shown on the touch panel display screen;
at least a button object shown on the touch panel display screen, wherein:
when an user touches a first location of the touch panel display screen, the pointing object moves to a second location proximate to the touched first location within the limits of the touch panel display screen;
when the user touches the button object, the touch panel display aiding interface simulate a click of a computer pointing device button; and
when the user touches the button object by means of the pointing member while moving the pointing member, the pointing object moves along with the pointing member.

2. The touch panel display aiding interface of claim 1, wherein the button object moves along with the pointing object.

3. The touch panel display aiding interface of claim 1, wherein the button object and the pointing object are integrated within a single object.

4. The touch panel display aiding interface of claim 1, wherein the button object further includes a button icon and a button region.

5. The touch panel display aiding interface of claim 1, further comprising at least a rolling-action object that simulates a computer pointing device rolling when the user touches the rolling-action object.

6. The touch panel display aiding interface of claim 5, wherein the rolling-action object moves along with and proximate to the pointing object within the touch panel display screen.

7. A touch panel display aiding interface suitable for use with a touch panel display screen, wherein an user may touch different locations of the touch panel display screen by means of a pointing member, the aiding interface comprising:
a pointing object shown on the touch panel display screen;
at least a button object shown on the touch panel display screen, wherein:
when the user touches the button object, the touch panel display aiding interface simulates a click of a computer pointing device button; and
when the user touches the button object by means of the pointing member while moving the pointing member, the pointing object moves along with the pointing member.

8. The touch panel display aiding interface of claim 7, wherein when the user successively touches a first location and a second location of the touch panel display screen, the pointing object only moves a distance parallel to the distance from the first location to the second location touched on the touch panel display screen.

9. The touch panel display aiding interface of claim 7, wherein the button object moves along with the pointing object.

10. The touch panel display aiding interface of claim 7, wherein the button object and the pointing object are integrated within a single object.

11. The touch panel display aiding interface of claim 7, wherein the button object further includes a button icon and a button region.

12. The touch panel display aiding interface of claim 7, further comprising at least a rolling-action object that simulates a computer pointing device rolling when the user touches the rolling-action object.

13. The touch panel display aiding interface of claim 7, wherein the rolling-action object moves along with and proximate to the pointing object within the touch panel display screen.
